(19) United States
(12) Patent Application Publication
(10) Pub. No.: US 2019/0251212 A1
(43) Pub. Date: Aug. 15, 2019

(54) Method for Creating a Netlist

(71) Applicant: dSPACE digital signal processing and control engineering GmbH, Paderborn (DE)

(72) Inventors: Marc DRESSLER, Paderborn (DE); Matthias BOCKELKAMP, Paderborn (DE)

(21) Appl. No.: 16/274,951

(22) Filed: Feb. 13, 2019

(30) Foreign Application Priority Data
Feb. 14, 2018 (DE) 102018103273.0

(51) Int. Cl. G06F 17/50

(52) U.S. Cl. CPC G06F 17/505; G06F 17/5054

(57) ABSTRACT

A method is disclosed for creating a netlist for the configuration of an FPGA, wherein the code of a first program comprises a multiplicity of subroutines. The code of the first program can be combined with the code of a second program to form a third program. A netlist for the configuration of an FPGA can be created from the third program, wherein at least one first subroutine of the first program is not used at the runtime of the third program. The first subroutine can be recognized in an automated manner, and a fourth program can be created on the basis of the first program. Also, the first subroutine can be removed during the creation of the fourth program, such that the fourth program does not contain the first subroutine.

### CROSS-REFERENCE TO RELATED APPLICATIONS

This application claims priority to German Patent Application No. 102018103273.0, filed on Feb. 14, 2018, the contents of which are incorporated herein by reference in their entirety and for all purposes.

### FIELD OF THE INVENTION

The present disclosure generally relates to a method for creating a netlist for the configuration of an FPGA.

### BACKGROUND OF THE INVENTION

As an example, the European patent application having the file reference 16168055.8 discloses a method for creating a netlist. An overall netlist composed of two PLD codes is generated in that case.

Then, during the development process of a netlist, the code for the netlist is often altered in a plurality of iterations. In addition, netlists can be used in a plurality of projects. In this regard, provision can be made for the code of a first program to provide a multiplicity of basic functions, and for the code of the first program to be joined together in each case with the code of a second program in a project. The code of the second program then provides project-specific functions. In this case, a project-specific function can replace a basic function. In this case, the basic function replaced is removed during the creation of the overall netlist.

Against this background, the object of the invention is to specify a device that develops the prior art.

### BRIEF DESCRIPTION OF THE DRAWINGS

FIG. 1 illustrates a schematic view of an example method, according to a first embodiment of the present disclosure.

FIG. 2 illustrates a schematic view of an example method, according to a second embodiment of the present disclosure.

FIGS. 3A-3D illustrate a schematic view of an example sequence, according to a third embodiment of the present disclosure.

FIGS. 4A-4C illustrate a schematic view of an example sequence, according to a fourth embodiment of the present disclosure.

FIG. 5 illustrates primary steps of an example method, according to an embodiment of the present disclosure.

FIGS. 6A-6C illustrate a schematic view of an example sequence, according to a fifth embodiment of the present disclosure.

FIGS. 6D-6F illustrate schematic views of example wrapper programs, according to various embodiments of the present disclosure.

FIGS. 7A-7E illustrate schematic views of example “fourth programs,” according to various embodiments of the present disclosure.

### DETAILED DESCRIPTION

According to various embodiments, a netlist for the configuration of an FPGA can be created. In particular, the code of a first program can comprise a multiplicity of subroutines, and the code of the first program can be combined with the code of a second program to form a third program. Further, a netlist for the configuration of an FPGA can be created from the third program, wherein at least one first subroutine of the first program is not used at the runtime of the third program. The first subroutine can be recognized in an automated manner.

Also, a fourth program can be created on the basis of the first program. Further still, the first subroutine can be removed during the creation of the fourth program, such that the fourth program does not contain the first subroutine.

It should be noted that the code of the first program and the code of the second program can be present in different forms. In this regard, a code can be present, for example, as textual code. Textual code can be present, for example, in a hardware description language such as VHDL. Subroutines can be identified in textual code, for example by means of markers. Such markers can be, for example, comments, attributes, or so-called pragmas. By means of markers, the subroutines can easily be recognized and removed from the code as necessary. Alternatively, a code can be present as a graphical model. Graphical models are known, for example, from the development environment Simulink from The MathWorks. In a graphical model, a subroutine can be represented as a submodel, wherein submodel should not be understood to necessarily mean a hierarchical subdivision. A submodel identifies a part of the model as being associated. Alternatively, a code can be present as a netlist. In the netlist, subroutines can be identified by means of markers. A marker of a subroutine can be effected, for example, by elements of a subroutine in the netlist acquiring specific names that can be taken as a basis for establishing the assignment to the subroutine. In this case, elements can be signals and also logic elements of a netlist. Netlists can contain information about the positioning of the logic elements and the routing between the logic elements. Code can also be present in encrypted form, for example in the form of encrypted netlists.

For combining the code of the first program and the code of the second program, the codes can be brought to the same form. In this regard, it is known that a graphical model can be converted into a textual code or a netlist and that a textual code can be converted into a netlist.

One advantage of the method according to the invention is that the fourth program contains only those subroutines of the first program which are required for interaction with the code of the second program. In further iterations of the project, therefore, the code of the fourth program can be used instead of the code of the first program. Since the code of the fourth program is smaller than the code of the first program, the creation of a netlist for the configuration of an FPGA is accelerated.

In one advantageous embodiment, the second program comprises a second subroutine, wherein, when the first program is combined with the second program, the second subroutine of the second program is the cause of the fact that the first subroutine of the first program will not be used at the runtime of the third program.

In this embodiment, the first subroutine of the first program is deactivated by the second subroutine of the second program. It is not necessary to alter the code of the first program. The configuration of the second subroutine of the second program determines whether the first subroutine of the first program is used at the runtime of the third program. In this context, the fact that the first subroutine is not used means that the first subroutine objectively does not fulfil a purpose. This may be characterized, for example, by the fact that the output values of the first subroutine are neither processed further in the FPGA nor output by the FPGA.

An unused first subroutine can also be understood to mean a subroutine which does not react dynamically to changing input values. In other words, the output values of the first subroutine do not change depending on input values, and the output values of the first subroutine are constant. In this case, these constant output values of the first function can be processed further in the FPGA or be output by the FPGA. During the creation of the fourth program, the output values for the first subroutine in the fourth program are replaced by constant output values. During the creation of the fourth program, the code of the first subroutine is then not carried over into the fourth program.

It goes without saying that the second subroutine of the second program can also be the cause of the fact that a third subroutine of the first program cannot be used at the runtime of the third program. Likewise, a fourth subroutine of the second program can be the cause of the fact that a fifth subroutine of the first program cannot be used. The subroutines are simply counted consecutively here; therefore, the first subroutine is situated in the first program, the second subroutine in the second program, the third subroutine in the first program, the fourth subroutine in the second program, and the fifth subroutine in the first program.

In a further embodiment, as a result of an analysis of the first program and of the second program, in particular before or during the combination of the first program and the second program to form the third program, it is recognized that the first subroutine will not be used in the third program.

Even before the code of the first program is combined with the code of the second program, in the joint consideration of both codes, all information is present for deciding whether the first subroutine will be used in the third program. By way of example, it may be recognized that the output data of the first subroutine are not used. Under this circumstance, it is evident that the first subroutine is not used in the third program.

This subroutine can therefore be removed without adversely affecting the functionality of the third program. By recognizing the unused subroutine by means of the analysis of the first and second programs, it is possible to remove the first subroutine of the first program before the third program is created. Removing a subroutine can also mean that the interfaces of the subroutine to be removed with input and output values of the subroutine are maintained and only the actual code of the subroutine that uses the input values to determine the output values is removed. As a result of the saving, the third program becomes smaller and can be processed more rapidly.

In one embodiment, the fourth program is created by compiling a wrapper program, wherein the first program is embedded into the wrapper program, wherein the wrapper program has the same data inputs and data outputs as the first program, wherein the wrapper program is configured on the basis of an analysis of the second program such that if the second program applies a constant value to the first data input, the wrapper program applies the same constant value to the first data input, and/or if the second program does not connect the first data input to a data source, the wrapper program does not link the first data input toward the outside, and/or if the second program does not connect the first data output to a data sink, the wrapper program does not link the first data output toward the outside.

The wrapper program preferably has an interface identical to the first program, that is to say that the data inputs and data outputs of the first program are identical to the data inputs and data outputs of the wrapper program. The data outputs of the first program are passed through the wrapper program. In the wrapper program, only the data outputs of the first program which in the second program are assigned to a data sink, for example an FPGA pin or a data input of the second program, are connected toward the outside. The configuration of the wrapper program exploits the fact that data outputs of the first program which are not assigned to an FPGA pin or data input of the second program do not fulfil a function. The absent connection in the wrapper program is recognized by the compiler and the unused subroutine supplying the unused data output of the first program with values is removed. The unused data output can optionally be allocated a constant or be identified in the code specifically as “unused”. As a result of such an identification, the data output is maintained in the fourth program, which facilitates the combination with the second program, but is recognized by the compiler directly as being unused.

An analogous procedure can be adopted for data inputs of the first program. If the analysis of the second program ascertains that the second program is the cause of a data input not being connected to a data source, for example an FPGA pin or a data output of the second program, then the data input is not passed through the wrapper program. If the analysis of the second program ascertains that a constant will be present at a data input of the first program at the runtime, then the data input is not passed through the wrapper program, rather in the wrapper program a constant is applied to the data input of the first program. The code can already be optimized during the compilation of the wrapper program with the embedded first program to form the fourth program. This accelerates the creation of the third program during the combination of the fourth program with a second program. The data input of the wrapper program is maintained, which facilitates combination with the second program, but is recognized by the compiler directly as being unused.

In one advantageous embodiment, during the compiling of the first program together with the wrapper program the first subroutine is removed and/or a constant value is applied to the first data output of the fourth program.

Advantageously, as a result of the use of the wrapper program, the removal of the first subroutine can be carried out by the compiler. During the compilation, unused parts of a program can be discarded by the compiler. The compiler can remove used and unused data outputs and remove any logic whose output is not guided directly or indirectly to used data outputs. The unused data output can optionally be additionally removed or allocated a constant value. Consequently, the compilation does not contain any unused program parts. The compilation also directly constitutes the desired fourth program.

Provision can be made for the first data output to be unused in a presetting. If the first data output is not assigned to an FPGA pin or to a data input by further information from the second program, then the first subroutine is removed by the compiler. The first data output can optionally be additionally removed.

In the second program, the first data output of the first subroutine can be connected to a data input of the second subroutine. The first data output is used as a result of this assignment. In this case, the first subroutine is not removed.

Provision can be made for the first data output to be connected to an FPGA pin as a default setting. If this setting is not changed, then the first subroutine is not removed. If the connection between the first data output and the FPGA pin is released by the second program, then the first subroutine is removed by the compiler.

In a further embodiment, as a result of a comparison of the third program with the first program, it can be determined that the first subroutine is not used in the third program.

In a further embodiment, the comparison is carried out before or after the creation of the netlist of the third program.

All objectively unused code portions can be removed during the creation of the netlist. Such a removal can be carried out directly by the compiler. A comparison of the code of the optimized third program with the code of the first program makes it possible to find the first subroutine that was removed by the optimization.

In another embodiment, as a result of an analysis of the first program and the second program, it is recognized that the first subroutine will not be used in the third program.

In one embodiment, the first subroutine is removed from a copy of the first program and the copy of the first program is stored as the fourth program.

Using a copy is advantageous if the intention is to maintain the first program in the original. Compilers often implicitly generate a copy and retain the original.

In one embodiment, the code of the first program is present as a graphical model, wherein the first subroutine is present as a submodel, wherein the removal of the first subroutine takes place by removal of the submodel.

A submodel can easily be delimited in the code of the first program and removed. The creation of the fourth program is simplified as a result.

In a further embodiment, the first program comprises a first multiplexer, wherein the second program configures the first multiplexer such that the first subroutine does not receive any signals at the runtime.

A benefit of this embodiment is that it can be recognized very easily whether the first subroutine is used. A multiplexer is understood to mean an element that outputs different output signals at one or more multiplexer outputs depending on a condition or a control signal, in particular a multiplexer driving signal. The output signals can be defined in the multiplexer itself or depend on one or more input signals. The second subroutine contains the information as to which position the first multiplexer is intended to assume at the runtime. This information is constant during the runtime, such that the first multiplexer will not switch at the runtime. The position of the first multiplexer and the consequences for the signal flow within the third program can thus be determined before the creation of the netlist. The information can be determined by an analysis of the first and second programs before the combination, or by an analysis of the third program after the combination. The information about the position of the first multiplexer can be used, for example, for creating or selecting a wrapper program. In the code of the third program, the use of the first subroutine can be recognized directly by way of the configuration of the first multiplexer. Since the first multiplexer will not switch at the runtime, it can be removed in any case.

The first multiplexer is connected to a data input of the first subroutine, and determines whether data from an FPGA pin, another subroutine, or no data are fed to the data input. If the first subroutine does not receive signals from another subroutine or an FPGA pin of the FPGA, the first subroutine objectively does not fulfil a purpose that changes at the runtime, and is therefore removed from the code of the fourth program. A function without input signals yields either no output signal or only a constant output signal. The function can thus either be removed and/or be replaced by a constant for the output signal. The first multiplexer is likewise removed during the creation of the fourth program.

A multiplexer is understood here to mean a switch comprising at least one data input, a data output and a terminal for a driving signal. The signal from the data input to the data output is connected or blocked depending on the value of the driving signal. A multiplexer can comprise a multiplicity of data inputs and/or data outputs. Depending on the value of the driving signal, data inputs are connected to data outputs. In this case, each data input can be connected to no, one or a plurality of data outputs.

In a further embodiment, the first program comprises a second multiplexer, wherein the second program configures the second multiplexer such that the results of the first subroutine at the runtime are not output at the runtime or processed further in the FPGA.

A benefit of this embodiment is that it can be recognized very easily whether the first subroutine is used. The second subroutine contains the information as to which position the second multiplexer is intended to assume at the runtime. This information is constant during the runtime, such that the second multiplexer will not switch at the runtime. The position of the second multiplexer and the consequences for the signal flow within the third program can thus be determined before the creation of the netlist. The information can be obtained by an analysis of the first and second programs before the combination or by an analysis of the third program after the combination. The information about the position of the second multiplexer can be used, for example, for creating or selecting a wrapper program. In the code of the third program, the use of the first subroutine can be recognized directly by way of the configuration of the second multiplexer or by the presence or absence of the subroutine if an optimization of the code is carried out directly during the combination of the first program with the second program.

The second multiplexer is connected to the first data output of the first subroutine and determines whether the data are passed to an FPGA pin, a data input of a subroutine, or nowhere. If the first subroutine outputs no signals to another subroutine or an output signal of the FPGA, the first subroutine objectively does not fulfil a purpose and is therefore removed from the code of the fourth program. The second multiplexer is likewise removed during the creation of the fourth program.

In the combination of the analysis of the first program and the second program with the first multiplexer or second multiplexer described above, it is possible to determine the use of the first subroutine from the configuration data for the first and/or second multiplexer from the second program. If it is recognized during the analysis of the second program from the configuration data for the first and/or second multiplexer of the first program that the first subroutine is not used in the third program, then the first subroutine is removed during the creation of the fourth program.

According to one implementation, the configuration data for the first and second multiplexers are implemented as a common, shared configuration datum.

A benefit of this is that with only one item of information, both the data input of the first subroutine and the first data output of the first subroutine are disconnected from FPGA terminals or other program parts. Thus, firstly, the first subroutine is very clearly marked as unused and information, and thus memory space, are thereby saved. The common, shared configuration datum can be present as information in the second program.

In a further embodiment, when the first program and the second program are merged, the fourth program is used instead of the first program.

By using the fourth program instead of the first program, the creation of the netlist for the configuration of an FPGA is accelerated since the fourth program does not contain the first subroutine and is therefore smaller than the first program.

According to one implementation, before the merging, a change is made to the second program, wherein the change does not affect the first subroutine.

The advantage of the accelerated creation of the netlist for the configuration of an FPGA is also achieved if the second program is altered. It is merely necessary to ensure that the change does not affect the first subroutine. If the second program is the cause of the fact that the first subroutine will not be used at the runtime of the third program, then also after the change the second program is the cause of the fact that the first subroutine will not be used at the runtime of the third program. If the second program feeds a constant value to the first subroutine, then the same constant value is fed to the first subroutine after the change. In combination with the first and/or second multiplexer described, the configuration data for the first and/or second multiplexer are maintained in the case of such a change.

In a further embodiment, the netlist of the third program is loaded onto an FPGA and executed on the FPGA.

Provided by this embodiment is a method for configuring an FPGA. The necessary steps of converting the netlist of the third program into a bit stream, loading the bit stream into an FPGA, configuring the FPGA by means of the bit stream are known to the person skilled in the art. The execution of a program on an FPGA is also referred to as the runtime of the program.

In combination with the use of the fourth program instead of the first program, the creation of a netlist for the configuration of an FPGA is accelerated. Since the fourth program does not contain the first subroutine, the combination of the code of the fourth program with the code of the second program is accelerated. The fourth program does not contain the first subroutine and, as a result, can more rapidly be joined together with the second program and converted into a bit stream. The configuration of an FPGA is ultimately accelerated.

The invention is explained in further detail below with reference to the drawings, wherein parts of identical type are denoted by identical designations. The embodiments are illustrated in a highly schematized fashion. As such, the distances and the lateral and vertical extents are not to scale, and unless indicated otherwise do not have derivable geometric relations with respect to one another.

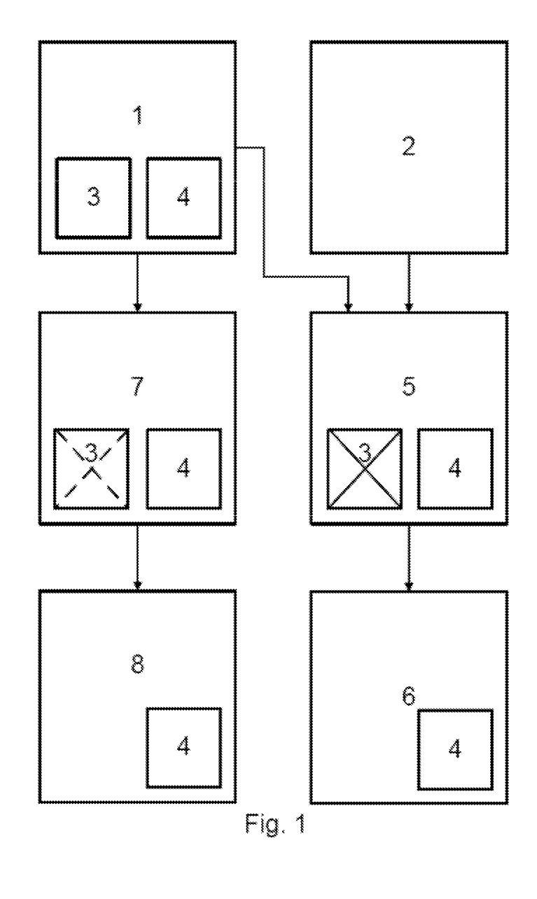

The depiction in FIG. 1 shows a schematic illustration of a first embodiment of a method according to the invention. The method proceeds from a code of a first program 1 and a code of a second program 2. In this case, the code of the first program contains a first subroutine 3 and a third subroutine 4. The codes of the first program 1 and the code of the second program 2 are combined to form a third program 5. It is recognized in an automated manner that the first subroutine 3 will not be used at the runtime of the third program 5. In this case, the first subroutine 3 can be removed from the third program 5, but this is not obligatory. A netlist 6 for the configuration of an FPGA is created from the third program 5. In this case, the netlist comprises the functionality of the third subroutine 4. The first subroutine 3 is removed from a copy 7 of the first program and the program thus produced is stored as fourth program 8.

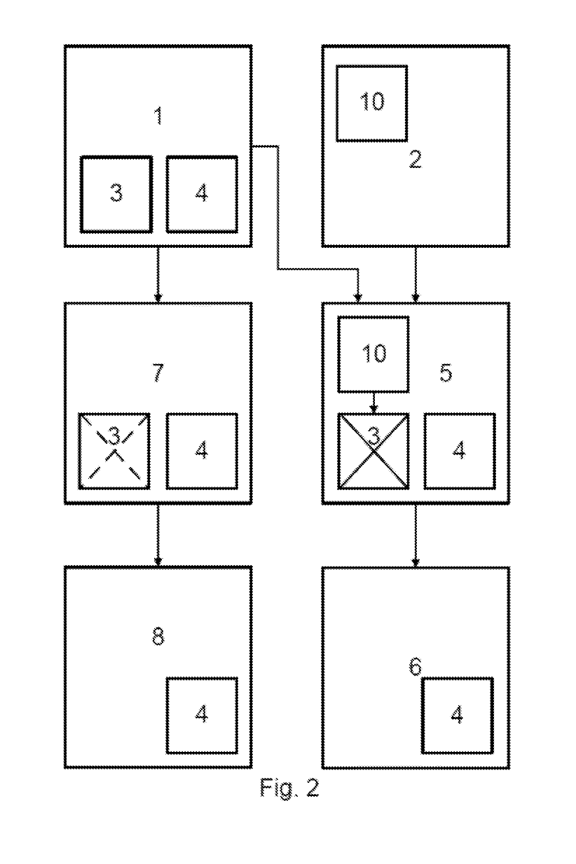

The depiction in FIG. 2 illustrates a further embodiment of a method according to the invention. Only the differences with respect to the depiction in FIG. 1 are explained below. The code of the second program 2 contains a second subroutine 10. The second subroutine 10 is carried over into the third program 5 when the code of the first program 1 and the code of the second program 2 are combined. The second subroutine 10 has the effect that the first subroutine 3 is not used at the runtime of the third program. This is recognized automatically, and the first subroutine 3 is removed from a copy 7 of the first program. The fact of whether the netlist 6 generated from the third program 5 comprises the functionality of the second subroutine 10 depends on whether the second subroutine 10 fulfils a further function alongside its effect on the first subroutine 3. If the second subroutine 10 does not fulfil a further purpose, it can be removed.

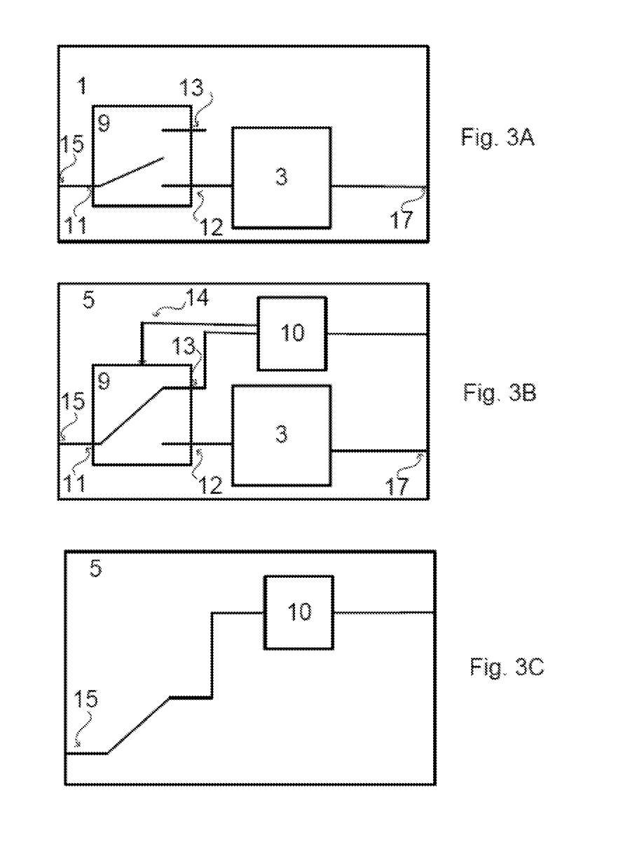

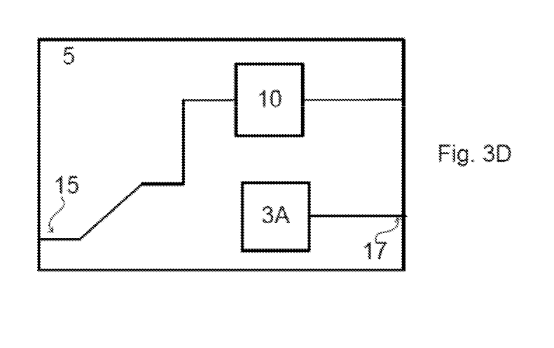

FIG. 3A shows a first program 1 such as could also be used in the embodiments in FIGS. 1 and 2. The first program 1 comprises a first subroutine 3 and a first multiplexer 9. The first program 1 receives data via a first data input 15 and forwards the data to a first multiplexer input 11. The first multiplexer 9 can forward a first multiplexer input 11 via a first multiplexer output 12 to the first subroutine 3 or to a second multiplexer output 13, wherein the second multiplexer output 13 is not connected further in the first program in this example. The terminal for the multiplexer driving signal for selecting the multiplexer output is not depicted here. The first subroutine 3 outputs data via a first data output 17.

FIG. 3B shows a third program 5 that arises after the combination of the first program 1 from FIG. 3A with a second program 2 in accordance with FIG. 2. The third program 5 comprises the first subroutine 3 from the first program 1, the first multiplexer 9 from the first program 1 and the second subroutine 10 from the second program 2. The second subroutine 10 configures the first multiplexer 9 by means of the multiplexer driving signal 14 such that the first multiplexer input 11 is connected to the second multiplexer output 13. The first multiplexer output 12 is unconnected as a result.

FIG. 3C shows the third program 5 from FIG. 3B after it has been recognized, in an automated manner, that the first subroutine 3 objectively does not fulfil a task, and therefore will not be used at the runtime of the third program 5. In this example, the first subroutine 3 is removed from the third program 5. The first multiplexer 9 is configured by the second subroutine 10 in such a way that it does not switch at the runtime of the third program 5. The first multiplexer 9 therefore objectively does not fulfil a function. The first multiplexer 9 is removed from the third program 5 and the first data input 15 is directly connected to the second subroutine 10. During the creation of the fourth program 8, the first subroutine 3 and the first multiplexer 9 are not taken into account or are removed from a copy 7 of the first program.

FIG. 3D shows the third program 5 from FIG. 3B after it has been recognized, in an automated manner, that the first subroutine 3 objectively does not fulfil a task, and therefore will not be used at the runtime of the third program 5. In this example, the first subroutine 3 is removed from the third program 5, and the output value of the subroutine 3 is replaced by a resulting constant output value 3A. The first multiplexer 9 is configured by the second subroutine 10 in such a way that it does not switch at the runtime of the third program 5. The first multiplexer 9 therefore objectively does not fulfil a function. The first multiplexer 9 is removed from the third program 5 and the first input signal 11 is directly connected to the second subroutine 10. During the creation of the fourth program 8, the output value of the first subroutine 3 is replaced by a constant output value 3A and the first multiplexer 9 is not taken into account or is removed from a copy 7 of the first program.

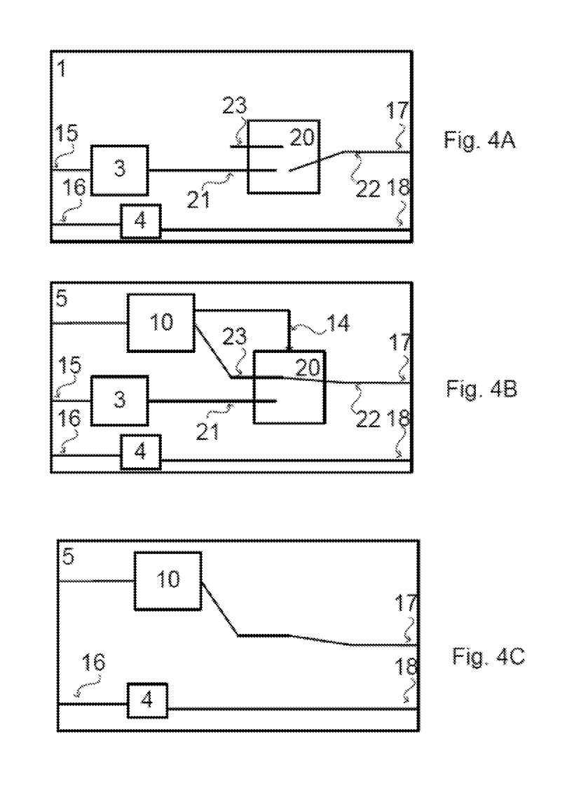

FIG. 4A shows an alternative first program 1 such as could also be used in the embodiments in FIGS. 1 and 2. The first program 1 comprises a first subroutine 3, a third subroutine 4 and a second multiplexer 20. The first program 1 receives data via a first data input 15 and forwards the data to the first subroutine 3. The second multiplexer 20 can forward a second multiplexer input 21 via a third multiplexer output 22 or forward a third multiplexer input 23 to the third multiplexer output 22. In this example, the second multiplexer input 21 is connected to an output signal of the first subroutine. The third multiplexer input 23 is not connected further in the first program 1 in this example. The third multiplexer output 22 is connected to the first data output 17 of the first program 1. The third subroutine 4 connects a second data input 16 of the first program 1 to a second data output 18 of the first program 1. In an alternative embodiment, the third multiplexer input 23 could be connected to a constant. The configuration of the second multiplexer 20 to a connection between the third multiplexer input 23 and the third multiplexer output 22 would render the first subroutine 3 objectively useless and the first subroutine 3 would not be taken into account during the creation of the fourth program 8.

FIG. 4B shows a third program 5 that arises after the combination of the first program 1 from FIG. 4A with a second program 2. The third program 5 comprises the first subroutine 3 from the first program 1, the third subroutine 4 from the first program 1, the second multiplexer 20 from the first program 1 and the second subroutine 10 from the second program 2. The second subroutine 10 configures the second multiplexer 20 by means of the multiplexer driving signal 14 such that the third multiplexer input 23 is connected to the third multiplexer output 22. The second multiplexer input 21 is unconnected as a result.

FIG. 4C shows the third program 5 from FIG. 4B after it has been recognized, in an automated manner, that the first subroutine 3 objectively does not fulfil a task, and therefore will not be used at the runtime of the third program 5. In this example, the first subroutine 3 was removed from the third program 5. The second multiplexer 20 is configured by the second subroutine 10 in such a way that it does not switch at the runtime of the third program 5. The second multiplexer 20 therefore objectively does not fulfil a function. The second multiplexer 20 is removed from the third program 5 and the output signal of the second subroutine 10 is directly connected to the first data output 17. During the creation of the fourth program 8, the first subroutine 3 and the second multiplexer are not taken into account since objectively they do not fulfil a function. The third subroutine 4 is not influenced by the second subroutine 10 and continues to be contained in the third program 5 and in the fourth program 8 without being altered.

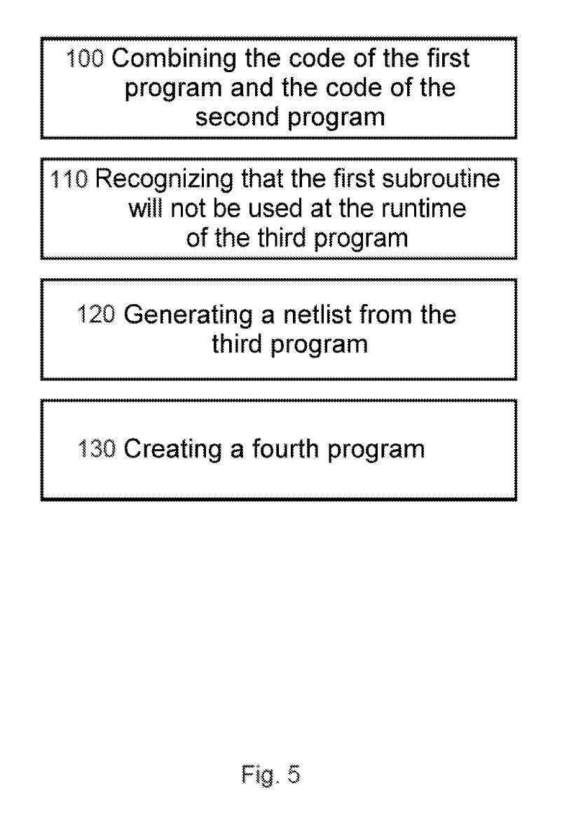

FIG. 5 illustrates primary steps of an example method, according to an embodiment of the present disclosure. In a first step 100, the code 1 of the first program and the code 2 of the second program are combined to form a third program. In a second step 110, it is recognized, in an automated manner, that the first subroutine 3 of the first program will not be used at the runtime of the third program, that is to say that the first subroutine objectively does not fulfil a task. It is noted that, in some embodiments of the invention, the automated recognition (i.e., the second step 110) can already be carried out before the combination of the code 1 of the first program with the code of the second program (i.e., before the first step 100). This is possible, for example, if the fact that the first subroutine is not used at the runtime of the third program can already be determined in an automated manner from the analysis of the code of the first program and the code of the second program. In a third step 120, a netlist for the configuration of an FPGA is generated from the third program. In a fourth step 130, a fourth program is created, wherein the fourth program does not contain the first subroutine, but otherwise is identical to the first program. It is noted that the fourth step 130 can be carried out independently of the third step 120 and independently of the first step 100, and the fourth step 130 can be carried out before the first step 100 and/or the third step 120.

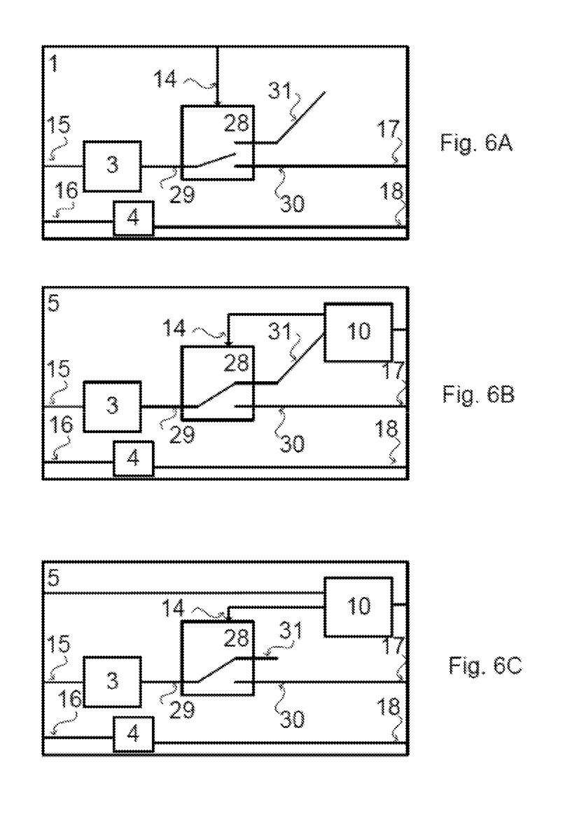

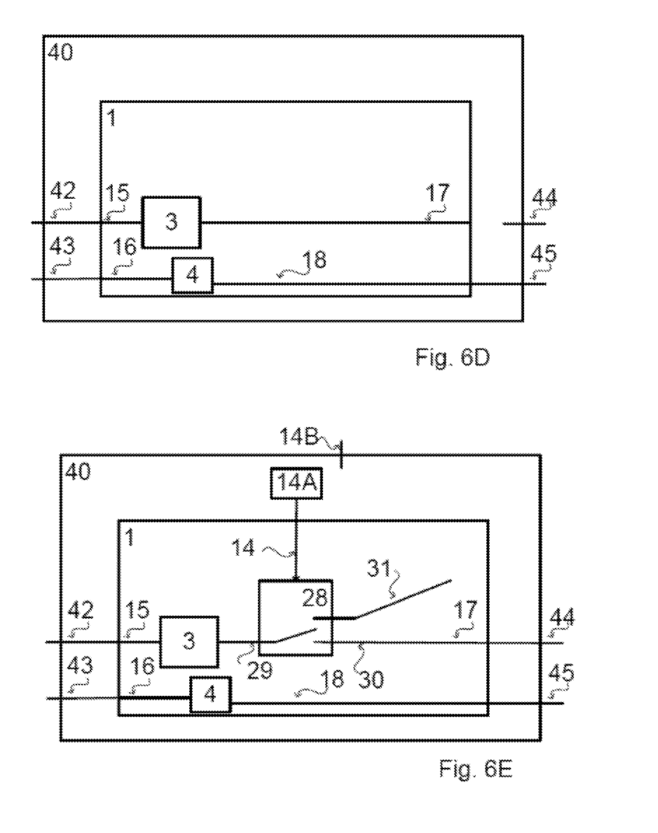

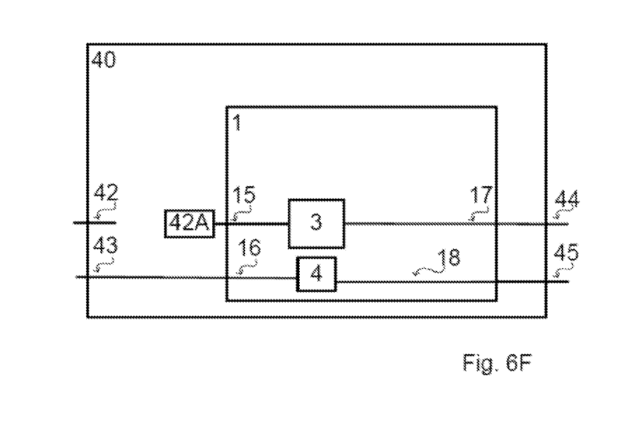

FIG. 6A shows an alternative first program 1 such as could also be used in the embodiments in FIGS. 1 and 2. The first program 1 comprises a first subroutine 3, a third subroutine 4 and a third multiplexer 28. The first program 1 receives data via a first data input 15 and forwards the data to the first subroutine 3. The function of the third multiplexer 28 is comparable with the function of the second multiplexer 20. The third multiplexer 28 can forward a fourth multiplexer input 29 to a fourth multiplexer output 30 or a fifth multiplexer output 31. In this example, the fourth multiplexer input is connected to an output signal of the first subroutine. In this example, the fourth multiplexer output 30 is connected to the first data output 17 of the first program 1. The fifth multiplexer output 31 is not connected further in the first program 1 in this example. The third subroutine 4 connects a second data input 16 of the first program 1 to a second data output 18 of the first program 1.

FIG. 6B shows a third program 5 that arises after the combination of the first program 1 from FIG. 6A with a second program 2. The third program 5 comprises the first subroutine 3 from the first program 1, the third subroutine 4 from the first program 1, the third multiplexer 28 from the first program 1 and the second subroutine 10 from the second program 2. The second subroutine 10 configures the third multiplexer 28 by means of the multiplexer driving signal 14 such that the fourth multiplexer input 29 is connected to the fifth multiplexer output 31. The fourth multiplexer output 30 is unconnected as a result. The fifth multiplexer output 31 is connected to an input of the second subroutine 10. In this example, the first subroutine 3 objectively fulfils a function since the results of the first subroutine 3 are used further as input values of the second subroutine 10 at the runtime in the FPGA.

FIG. 6C shows a third program 5 that arises after the combination of the first program 1 from FIG. 6A with an alternative second program 2. The third program 5 comprises the first subroutine 3 from the first program 1, the third subroutine 4 from the first program 1, the third multiplexer 28 from the first program 1 and the second subroutine 10 from the second program 2. The second subroutine 10 configures the third multiplexer 28 by means of the multiplexer driving signal 14 such that the fourth multiplexer input 29 is connected to the fifth multiplexer output 31. The fourth multiplexer output 30 is unconnected as a result. The fifth multiplexer output 31 is not connected further, however, in this example. The first subroutine 3 therefore objectively does not fulfil a function since the results of the first subroutine 3 are not output to a pin or processed further in the FPGA. In this example, the second subroutine 10 receives data via a further data input.

FIG. 6D shows a wrapper program 40 for creating a fourth program 8. The first program 1 comprises a first subroutine 3 and a third subroutine 4. The first program 1 is embedded into the wrapper program 40. The wrapper program thus has the same number of data inputs and data outputs as the first program 1. The wrapper program 40 comprises a third data input 42, which links the first data input 15 toward the outside and is thus connected to the first subroutine 3, and a fourth data input 43, which links the second data input 16 toward the outside and is thus connected to the third subroutine 4. In this example, it was recognized by means of an analysis of the first program 1 and the second program that the output value of the first subroutine 3 is not used further in the second program, nor is it forwarded to an I/O pin of the FPGA. Therefore, the second data output 17 of the first program 1 is not connected to the third data output 44 of the wrapper program 40. The second data output 18 of the first program 1 is connected to the fifth data output 45 of the wrapper program 40. The wrapper program 40 with the embedded first program 1 is then compiled. The combination constitutes the fourth program. The compilation can be used in the further program development instead of the first program 1 in order to accelerate the creation of a bit stream for the configuration of an FPGA in further development iterations.

FIG. 6E shows a further wrapper program 40 with an embedded first program 1. This example is based on the first program 1 from FIG. 6A, wherein the first program 1 is intended to be combined with a second program 2 to form the third program 5 from FIG. 6C. The wrapper program 40 has just the same number of data inputs and data outputs as the first program 1. As evident from FIG. 6A, the fourth multiplexer output 30 of the first program 1 is connected to the first data output 17 of the first program 1. It is recognized by means of an analysis of the second program 2 that the multiplexer driving signal 14 has a constant value at the runtime. The wrapper program 40 provides said constant value 14A and connects it to the multiplexer driving signal 14. The wrapper program has a dummy terminal 14B in order that the fourth program to be created has the same terminals as the first program 1. The terminal for the multiplexer driving signal 14 of the first program 1 and the dummy terminal 14B of the wrapper program 40 also constitute data inputs.

In this example, the second multiplexer 28 is driven by the multiplexer driving signal 14 such that it connects the fourth multiplexer input 29 to the fifth multiplexer output 31. As a result, the fourth multiplexer output 30 does not depend on the values at the fourth multiplexer input 29. The fourth multiplexer output 30 is connected to the third data output 44 of the wrapper program 40 via the first data output 17. The fourth data input 43 of the wrapper program is connected to the second data input 16 and thus to the third subroutine 4. As evident from FIG. 6A, the results of the third subroutine 4 are forwarded to the second data output 18 of the first program. The second data output 18 is connected to a fourth data output 45 of the wrapper program 40. The fifth multiplexer output 31 is not led out of the first program 1 and accordingly also not connected further in the wrapper program. During the compilation of the wrapper program 40 with the embedded first program 1, all logical connections and logics that lead only to the fifth multiplexer output 31 are removed by the compiler. In this example, compiling thus involves removing the first subroutine 3 and the second multiplexer 28. The compilation constitutes the fourth program. The compilation can be used in the further program development instead of the first program in order to accelerate the creation of a bit stream for the configuration of an FPGA in further development iterations.

FIG. 6F shows a further wrapper program 40 with an embedded first program 1. The fourth data input 43 of the wrapper program is connected to the second data input 16 and thus to the third subroutine 4. The results of the third subroutine 4 are forwarded to a second data output 18 of the first program. The second data output 18 is connected to a fourth data output 45 of the wrapper program 40. In this example, it was recognized by means of an analysis of the first program 1 and the second program that the input value of the first data input 15 assumes a constant value at the runtime. The wrapper program 40 provides this constant input value 42A and connects it to the first data input 15. The third data input 42 of the wrapper program 40 is therefore not connected to the first program 1. It is maintained in order that the compilation has the same terminals as the first program 1.

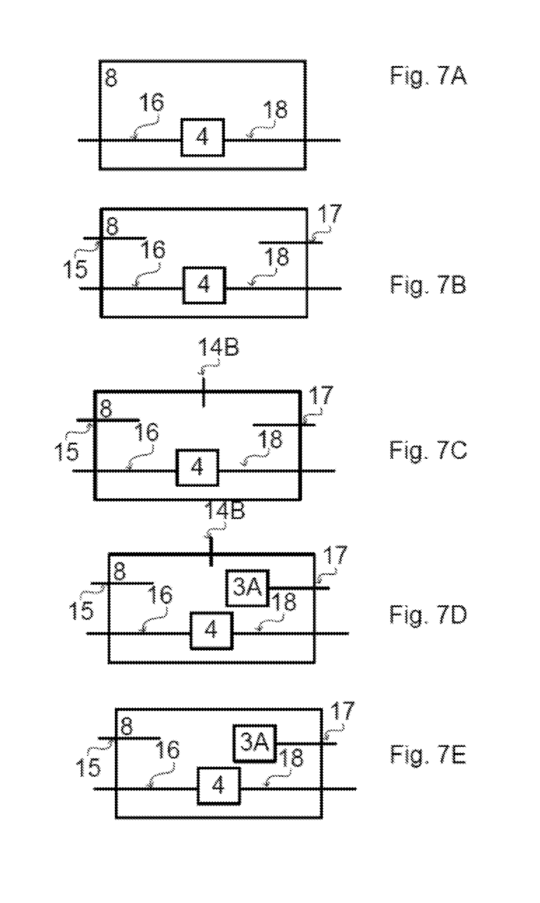

FIG. 7A shows a fourth program 8 that arises from the compilation of the wrapper program 40 together with the first program 1 from FIG. 6D. The first subroutine 3 was removed together with the third data input 42 and the third data output 44 during compiling. The fourth program still contains the third subroutine 4, wherein the third subroutine 4 is directly connected to the second data input 16 and the second data output 18 of the fourth program 8. Since the third data input 42 and the third data output 44 were removed, the fourth program comprises no first data input and no first data output. When the fourth program 8 is joined together with the second program 2, the absence of the first data input and the first data output does not pose a problem, in principle, if the terminals are not expected in the second program 2. However, all data inputs and data outputs, identically to the first program 1, are often expected by compilers, by the design or by the second program, with the result that absent data terminals of the fourth program 8 lead to error messages. The alternative compilation from FIG. 7B is therefore preferred. The fourth program 8 can thus be combined with the second program 2 to form a third program 5, wherein the third program 5 that arises can be created more rapidly than a third program 5 joined together from the first program 1 and the second program 2.

FIG. 7B shows an alternative fourth program 8 that arises from the compilation of the wrapper program 40 together with the first program 1 from FIG. 6D. Only the differences with respect to FIG. 7A are described below. In contrast to the fourth program 8 from FIG. 7A, the first data input 15 and the first data output 17, which were connected to the first subroutine 3 in the first program, are maintained here. Since the fourth program 8 has the same data inputs and data outputs as the first program 1, it can be used instead of the first program without any problems. The same data inputs and data outputs means here that the names, data types and bit widths of the data inputs and data outputs remain the same. The fourth program 8 can thus be combined with the second program 2 to form a third program 5, wherein the third program 5 that arises can be created more rapidly than a third program 5 joined together from the first program 1 and the second program 2. Since the third program joined together from the fourth program 8 and the second program 2 does not contain the first subroutine 3, it can be optimized more rapidly, for example.

FIG. 7C shows a fourth program 8 that arises from the compilation of the wrapper program 40 together with the first program 1 from FIG. 6E. The fourth program 8 still contains the third subroutine 4, wherein the third subroutine 4 is directly connected to the second data input 16 and the second data output 18 of the fourth program 8. The first subroutine 3 and the second multiplexer 28 were removed since they clearly do not fulfil a purpose. The first data input 15, the first data output 17 and the dummy terminal 14B are maintained in order that the fourth program has the same terminals as the first program. The fourth program 8 can thus be combined with the second program 2 to form a third program 5, wherein the third program 5 that arises can be created more rapidly than a third program 5 joined together from the first program 1 and the second program 2.

FIG. 7D shows an alternative fourth program 8 that arises from the compilation of the wrapper program 40 together with the first program 1 from FIG. 6E. Only the differences with respect to FIG. 7C are described below. In this example, the second multiplexer 28 outputs a constant signal on the fourth multiplexer output 30. During compiling, therefore, the second multiplexer is replaced by a constant output value 3A and is connected to the third data output 17.

FIG. 7E shows a fourth program 8 that arises from the compilation of the wrapper program 40 together with the first program 1 from FIG. 6F. During compiling, the result of the first subroutine 3 was determined from the constant input value 42A and was defined as a constant output value 3A in the fourth program 8 for the third data output 17. The first data input 15 is maintained in order that the fourth program has the same terminals as the first program. The fourth program 8 can thus be combined with the second program 2 to form a third program 5, wherein the third program 5 that arises can be created more rapidly than a third program 5 joined together from the first program 1 and the second program 2.

It is noted that the terms “program” and “code of a program” are used synonymously herein. A program is always present as code, wherein said code can assume different manifestations, for example as textual code, as a graphical model, as a netlist or as a bit stream.

### LIST OF REFERENCE SIGNS

1 (code of the) first program
2 (code of the) second program
3 first subroutine (of the first program)
3A constant output value
4 third subroutine
5 third program
6 netlist (of the third program)
7 copy of the first program
8 (code of the) fourth program
9 first multiplexer
10 second subroutine (of the second program)
11 first multiplexer input (of the first multiplexer)
12 first multiplexer output (of the first multiplexer)
13 second multiplexer output (of the first multiplexer)
14 multiplexer driving signals (of the first or respectively second multiplexer)
14A constant value
14B dummy terminal
15 first data input (of the first, third or fourth program)
16 second data input (of the first, third or fourth program)
17 first data output (of the first, third or fourth program)
18 second data output (of the first, third or fourth program)
20 second multiplexer
21 second multiplexer input (of the second multiplexer)
22 third multiplexer output (of the second multiplexer)
23 third multiplexer input (of the second multiplexer)
28 third multiplexer
29 fourth multiplexer input (of the third multiplexer)
30 fourth multiplexer output (of the third multiplexer)
31 fifth multiplexer output (of the third multiplexer)
40 wrapper program
42 third data input (of the wrapper program)
42A constant input value
43 fourth data input (of the wrapper program)
44 third data output (of the wrapper program)
45 fourth data output (of the wrapper program)

1. A method for creating a netlist for a configuration of an FPGA,
wherein a code of a first program comprises a multiplicity of subroutines,
wherein the code of the first program is combined with a code of a second program to form a third program,
wherein a netlist for the configuration of an FPGA is created from the third program,
wherein
at least one first subroutine of the first program is not used at a runtime of the third program,
wherein the first subroutine is recognized in an automated manner,
wherein a fourth program is created on a basis of the first program, and
wherein the first subroutine is removed during the creation of the fourth program, such that the fourth program does not contain the first subroutine.

2. The method as claimed in claim 1, wherein the second program comprises a second subroutine, and wherein said at least one first subroutine of the first program not being used at the runtime of the third program is caused by the second subroutine of the second program.

3. The method as claimed in claim 1, wherein, as a result of an analysis of the first program and of the second program, it is recognized that the first subroutine will not be used in the third program.

4. The method as claimed in claim 3, wherein the analysis is performed before or during the combination of the first program and the second program to form the third program.

5. The method as claimed in claim 1, wherein the fourth program is created by compiling a wrapper program, wherein the first program is embedded into the wrapper program, wherein the wrapper program has same data inputs and data outputs as the first program, and wherein the wrapper program is configured on a basis of an analysis of the second program such that if the second program applies a constant value to a first data input, the wrapper program applies a same constant value to the first data input, and/or if the second program does not connect the first data input to a data source, the wrapper program does not link the first data input toward an outside, and/or if the second program does not connect a first data output to a data sink, the wrapper program does not link the first data output toward the outside.

6. The method as claimed in claim 5, wherein during the compiling of the first program together with the wrapper program, the first subroutine is removed and/or a constant value is applied to the first data output of the fourth program.

7. The method as claimed in claim 1, wherein, as a result of a comparison of the third program with the first program, it is recognized that the first subroutine is not used in the third program.

8. The method as claimed in claim 1, wherein, as a result of an analysis of the first program and the second program, it is recognized that the first subroutine will not be used in the third program.

9. The method as claimed in claim 1, wherein the first subroutine is removed from a copy of the first program and the copy of the first program is stored as the fourth program.

10. The method as claimed in claim 1, wherein the code of the first program is present as a graphical model, wherein the first subroutine is present as a submodel, and wherein the removal of the first subroutine takes place by removal of the submodel.

11. The method as claimed in claim 1, wherein the first program comprises a first multiplexer, and wherein the second program configures the first multiplexer such that the first subroutine does not receive any signals at the runtime.

12. The method as claimed in claim 1, wherein the first program comprises a second multiplexer, and wherein the second program configures the second multiplexer such that results of the first subroutine at the runtime are not output via an FPGA pin or processed further in the FPGA.

13. The method as claimed in claim 1, wherein upon a merging of the first program and the second program, the fourth program is used instead of the first program.

14. The method as claimed in claim 13, wherein before the merging, a change is made to the second program, and wherein the change does not affect the first subroutine.

15. The method as claimed in claim 1, wherein the netlist of the third program is loaded onto an FPGA and executed on the FPGA.
